(19) United States
(12) Patent Application Publication
(10) Pub. No.: US 2025/0038327 A1
(43) Pub. Date: Jan. 30, 2025

(54) LAMINATED BATTERY AND METHOD OF MANUFACTURING LAMINATED BATTERY

(71) Applicant: TOYOTA JIDOSHA KABUSHIKI KAISHA, Toyota-shi (JP)

(72) Inventors: Masashi CHIHARA, Nagoya-shi (JP); Kenichi Kakishita, Nagoya-shi (JP); Sumiko Kito, Nagoya-shi (JP)

(73) Assignee: TOYOTA JIDOSHA KABUSHIKI KAISHA, Toyota-shi (JP)

(21) Appl. No.: 18/655,502

(22) Filed: May 6, 2024

(30) Foreign Application Priority Data
Jul. 27, 2023 (JP) 2023-122778

(51) Int. Cl. H01M 50/24; H01M 50/186

(52) U.S. Cl. CPC H01M 50/24; H01M 50/186

(57) ABSTRACT

The laminated battery has an electrode body and a laminate film encapsulating the electrode body, and the laminate film has a fused portion in which end parts are overlapped and an inner surface is fused, and the fused portion has two bent parts bent in an angular shape or an arcuate shape so as to have an angle of 90° or less, and a roll part arranged closer to the front end side of the fused portion than the bent parts at 2 places and rounded in a roll shape.

### CROSS-REFERENCE TO RELATED APPLICATION

This application claims priority to Japanese Patent Application No. 2023-122778 filed on Jul. 27, 2023, incorporated herein by reference in its entirety.

### BACKGROUND

### 1. Technical Field

The present disclosure relates to a laminated battery and a method of manufacturing a laminated battery.

### 2. Description of Related Art

In a laminated battery in which an electrode body is covered by laminate films, a part of the laminate films is fused to form a fused portion in order to seal the electrode body.

For example, Japanese Unexamined Patent Application Publication No. 2019-200973 (JP 2019-200973 A) discloses a method of manufacturing a secondary battery in which a bent portion is provided at at least one end portion of a laminated exterior body. The method includes: bringing a holding plate into contact with a bending base point at the end portion of the exterior body; and forming the bent portion after the contact step by sliding the holding plate and a pressing plate disposed at a position facing the holding plate to sandwich the end portion to bend the end portion about the base point, and holding the end portion between the holding plate and the pressing plate. A surface of the pressing plate that slides against the end portion includes an inclined surface that bends the end portion and a holding surface that holds the end portion. In a cross section orthogonal to the width direction of the pressing plate, the inclined surface is inclined such that the sectional area of the pressing plate decreases in the sliding direction. The inclined surface is inclined in the width direction.

### SUMMARY

There has conventionally been a demand to improve structural efficiency by saving space in a fused portion of laminate films in a laminated battery, and therefore a part of the fused portion is bent to form a bent portion. However, a stress is occasionally concentrated on the bent portion to tear the laminate films.

The present disclosure has been made in view of the above circumstances, and has an object to provide a laminated battery capable of suppressing the occurrence of tear in laminate films while enhancing the structural efficiency of a fused portion, and a method of manufacturing such a laminated battery.

1> A laminated battery including: an electrode body; and laminate films that cover and seal the electrode body, in which:
the laminate films include a fused portion at which end portions overlap each other and inner surfaces are fused; and
the fused portion includes two bent portions bent in an angular or arcuate shape so as to have an angle of 90° or less, and a rolled portion disposed on a distal end side of the fused portion with respect to the two bent portions and rolled in a rolled shape.

<2> The laminated battery according to <1>, in which the bent portions have an angle of 60° or more.

<3> The laminated battery according to <1> or <2>, in which a height of the fused portion in a thickness direction of the electrode body is equal to or less than a thickness of a portion of the laminated battery including the electrode body.

<4> A method of manufacturing a laminated battery including an electrode body, and laminate films that cover and seal the electrode body,
the laminate films including a fused portion at which end portions of the laminate films overlap each other and inner surfaces are fused, the method including:
rolling the fused portion into a rolled shape from a distal end side; and
forming two bent portions by pressing the rolled fused portion from at least two directions using a pressing member and bending the fused portion into an angular or arcuate shape so as to have an angle of 90° or less.

<5> The method of manufacturing a laminated battery according to <4>, in which the pressing includes pressing the fused portion from three directions using the pressing member.

According to the present disclosure, it is possible to provide a laminated battery capable of suppressing the occurrence of tear in laminate films while enhancing the structural efficiency of a fused portion, and a method of manufacturing such a laminated battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a laminated battery according to an embodiment of the present disclosure;

FIG. 2 is a schematic cross-sectional view illustrating one step of a method for manufacturing a laminated battery according to an embodiment of the present disclosure;

FIG. 3 is a schematic cross-sectional view illustrating one step of a method for manufacturing a laminated battery according to an embodiment of the present disclosure;

FIG. 4 is a schematic top view and a schematic cross-sectional view illustrating a roll process in a method of manufacturing a laminated battery according to an embodiment of the present disclosure;

FIG. 5 is a schematic cross-sectional view illustrating one step of a process for manufacturing a laminated battery according to an embodiment of the present disclosure; and

FIG. 6 is a schematic cross-sectional view illustrating an exemplary solid-state cell.

### DETAILED DESCRIPTION OF EMBODIMENTS

### Laminated Battery

A laminated battery according to an embodiment of the present disclosure includes an electrode body and a laminate film encapsulating the electrode body. The laminate film has a fused portion in which end portions are superposed to each other and an inner surface is fused. The fused portion includes two bent portions bent in an angular or arcuate shape so as to have an angle of 90° or less, and a roll portion arranged on the distal end side of the fused portion rather than the two bent portions and rolled in a roll shape.

Hereinafter, an embodiment of a laminated battery according to an embodiment of the present disclosure will be described with reference to the drawings. Each drawing shown below is schematically shown, and the size and shape of each part are appropriately exaggerated for easy understanding.

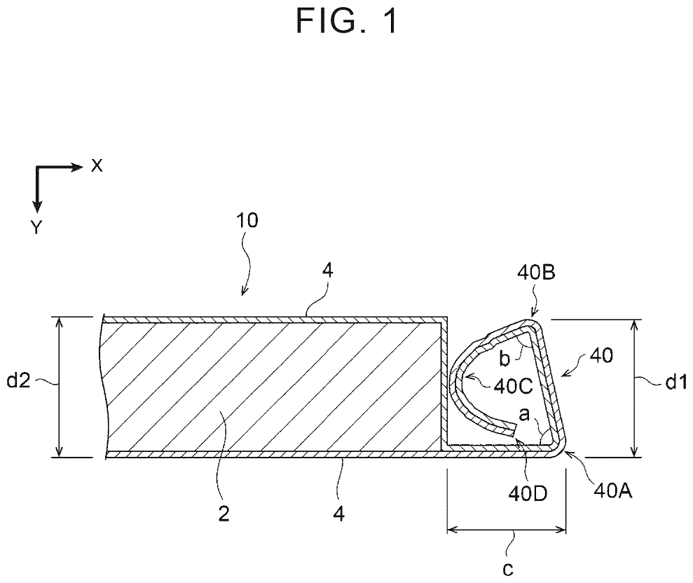

FIG. 1 is a schematic cross-sectional view illustrating a laminated battery according to an embodiment of the present disclosure.

The laminated battery 10 illustrated in FIG. 1 includes an electrode body 2 and a laminate film 4 that covers and encloses the electrode body 2. The laminate film 4 has a fused portion 40 in which end portions are superposed to each other and the inner surface is fused. The fused portion 40 includes two bent portions 40A, 40B bent in an angular shape or an arcuate shape so as to have an angle of 90° or less, and a roll portion 40C which is disposed on the distal end-side 40D of the fused portion 40 rather than the two bent portions 40A, 40B and is rolled. The roll portion 40C is rolled toward the inner direction of the fused portion 40 having two bent portions 40A, 40B (i.e., the direction of the side which is 90° or less in the two bent portion 40A, 40B). Note that the roll portion refers to a portion having a continuous curved shape.

The laminated battery according to the embodiment of the present disclosure has the above-described configuration, so that it is possible to increase the structural efficiency of the fused portion and suppress the occurrence of a tear in the laminate film.

First, the laminated battery according to the embodiment of the present disclosure has a roll portion that is rolled in a roll shape on the distal end side of the fused portion, and thus can be made space-saving, and the structural efficiency in the fused portion can be increased.

Further, since the laminated battery has a roll portion on the distal end side of the fused portion rather than the two bent portions, the structural efficiency can be increased as described above without making the angle of bending at the two bent portions an extremely acute angle (for example, a bent portion having an angle of 0°). In a bent portion having an extremely acute angle (for example, an angle of 0°), stress is concentrated at an acute angle, and a laminate film may be torn. However, in the embodiment of the present disclosure, since the structural efficiency can be increased without making the angle of bending at the two bent portions an extremely acute angle, the stress concentration on the corners can be relaxed and the occurrence of tearing in the laminate film can be suppressed.

As described above, according to the laminated battery of the embodiment of the present disclosure, it is presumed that the occurrence of the tear in the laminate film can be suppressed while the structural efficiency in the fused portion is increased.

### Angle of Bend

The angles of the two bent portions (for example, the angle a in the bent portion 40A and the angle b in the bent portion 40B in the laminated battery 10 shown in FIG. 1) are both bent in an angular shape or an arcuate shape so as to be 90° or less. When the angle is 90° or less, the structural efficiency in the fused portion can be increased. The angle of the two bent portions is preferably less than 90°, and more preferably 80° or less. In addition, the angle of the bent portions at the two positions is preferably 50° or more, more preferably 60° or more, and still more preferably 70° or more, from the viewpoint of suppressing the occurrence of tearing of the laminate film due to stress concentration.

### Height of Fused Portion

The height of the fused portion, that is, the height of the fused portion in the thickness direction of the electrode body (for example, in the direction of arrow Y in FIG. 1) (for example, in the laminated battery 10 shown in FIG. 1, the height d1 in the fused portion 40) is preferably equal to or less than the thickness of the portion having the electrode body in the laminated battery (for example, in the laminated battery 10 shown in FIG. 1, the height d2). When the height of the fused portion is equal to or less than the thickness of the portion having the electrode body, the structural efficiency of the battery can be increased.

### Width of Fused Portion

Width of the fused portion will be described. The width of the fused portion refers to the length from the end portion of the portion having the electrode body in the laminated battery to the end portion of the fused portion of the laminate film (for example, in the laminated battery 10 shown in FIG. 1, the width c of the fused portion 40) in the direction (for example, the arrow X direction in FIG. 1) on the side where the fused portion of the laminate film is formed when viewed from the electrode body side in the laminated battery. From the viewpoint of enhancing the structural efficiency of the battery, the width of the fused portion is preferably 0.5 mm or more and 2.0 mm or less, and more preferably 0.8 mm or more and 1.5 mm or less.

### Method for Manufacturing Laminated Battery

Next, a method of manufacturing a laminated battery according to an embodiment of the present disclosure will be described.

A method of manufacturing a laminated battery according to an embodiment of the present disclosure is a method of manufacturing a laminated battery including an electrode body and a laminate film that covers and encloses the electrode body, and the laminated battery includes a fused portion in which end portions of the laminate film are overlapped and an inner surface is fused.

The manufacturing method of the laminated battery includes a roll step of rolling the fused portion from the tip side to a roll shape, and a press step of pressing the pressing member from at least two directions against the rounded fused portion, and forming a bent portion at two positions by bending in an angular or arcuate shape so as to have an angle of 90° or less.

Hereinafter, an embodiment of a method for manufacturing a laminated battery according to an embodiment of the present disclosure will be described with reference to the drawings.

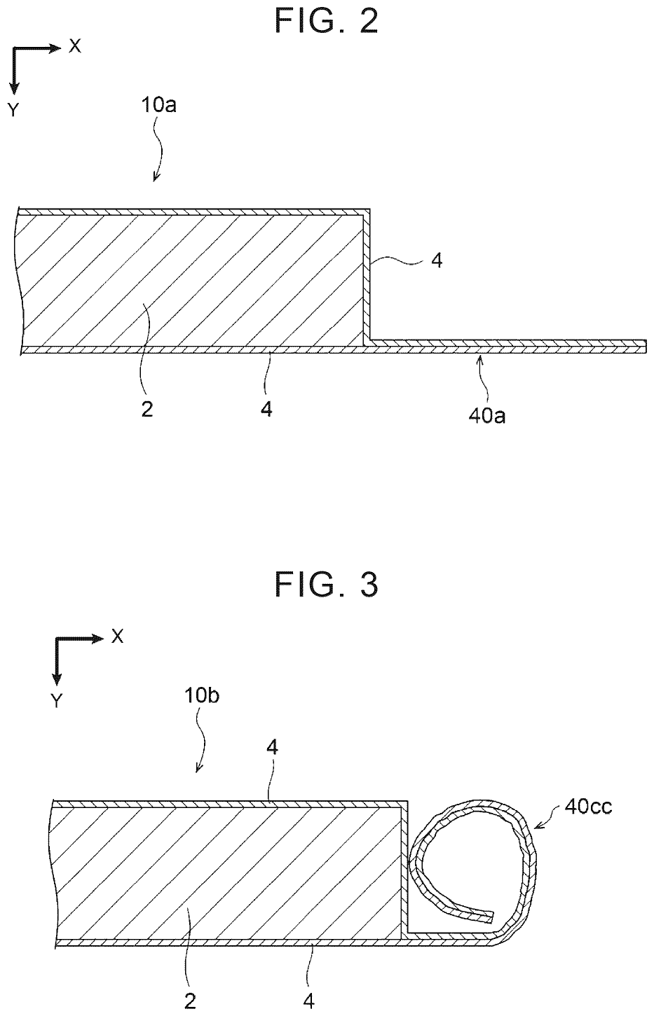

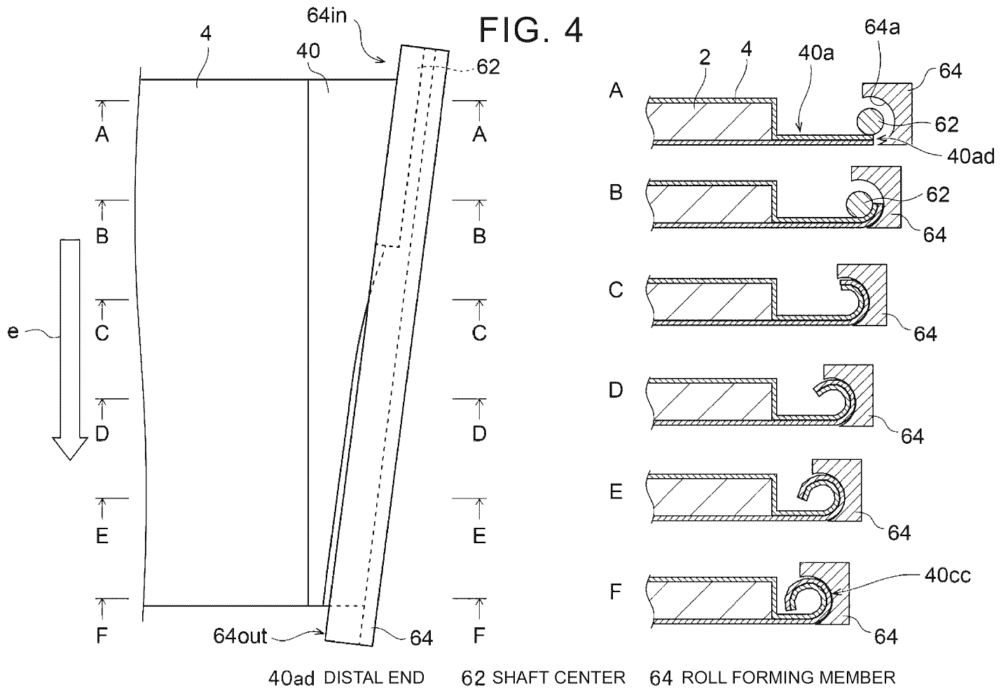

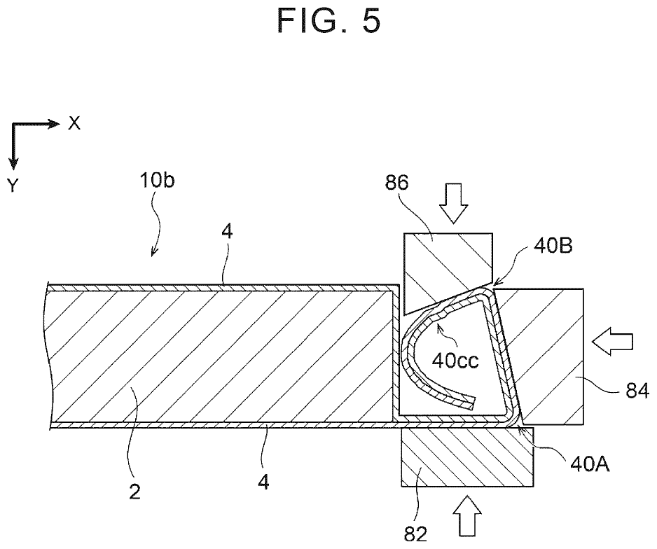

FIG. 2, FIG. 3, and FIG. 5 are schematic cross-sectional views illustrating one step of a method for manufacturing a laminated battery according to an embodiment of the present disclosure, and FIG. 4 is a schematic top view and a schematic cross-sectional view illustrating a roll step in a method for manufacturing a laminated battery according to an embodiment of the present disclosure.

First, as shown in FIG. 2, a laminated battery 10a is prepared which has an electrode body 2 and a laminate film 4 encapsulating the electrode body 2, has a fused portion 40a in which end portions of the laminate film 4 are overlapped and the inner surface is fused, and a bent portion or a rolled portion is not formed on the fused portion 40a.

### Roll Process

Next, a roll process is performed on the fused portion 40a in the laminated battery 10a to produce a laminated battery 10b having a fused portion 40cc rounded in a roll shape from the front end as shown in FIG. 3.

Here, an example of the roll process will be described in detail with reference to FIG. 4. FIG. 4 is a schematic top view (left side in FIG. 4) and a schematic cross-sectional view (right side in FIG. 4) illustrating a roll process in the method of manufacturing a laminated battery according to an embodiment of the present disclosure. A view of a schematic cross-sectional view (right side of FIG. 4) is a cross-sectional view showing a A-A cross-section in a schematic top view (left side of FIG. 4). Similarly, B of the schematic cross-sectional views is a view showing a B—B cross-section in a schematic top view, C of the schematic cross-sectional views is a view showing a C—C cross-section in a schematic top view, D of the schematic cross-sectional views is a view showing a D-D cross-section in a schematic top view, E of the schematic cross-sectional views is a view showing a E-E cross-section in a schematic top view, F of the schematic cross-sectional views is a view showing a F—F cross-section in a schematic top view.

In the forming process of the roll portion shown in FIG. 4, while moving the laminated battery 10a in the direction of arrow e in which no bent portion or roll portion is formed, by pressing the roll portion forming member 64 arranged with an inclination with respect to the arrow e direction to the fused portion 40a, to form a fused portion 40cc rounded in a roll shape.

The roll portion forming member 64 is inclined with respect to the direction of the arrow e, and has a circular inner surface 64a. In the roll portion forming member 64, the end 64in that is on a side in which the fused portion 40a of the laminated battery 10a moving in the direction of arrow e enters (i.e. the inlet side) is disposed at a position in which the distal end 40ad of the fused portion 40a does not contact the end 64in, as shown in FIG. A of the A-A position and the schematic cross-sectional view (right side in FIG. 4) of the schematic top view of FIG. 4 (left side in FIG. 4). Thereafter, as the laminated battery 10a moves in the direction of arrow e, as shown in FIG. 4 in B—B position of the schematic top view (left side in FIG. 4) and the schematic cross-sectional view (right side in FIG. 4) in FIG. B, the fused portion 40a starts to deform into a roll shape when the distal end 40ad of the fused portion 40a contacts the inner surface 64a of the roll portion forming member 64. A shaft center 62 is disposed at a position opposed to the inner surface 64a of the roll portion forming member 64 with the fused portion 40a interposed therebetween to assist the fused portion 40a to begin to deform in a roll shape. By providing the shaft center 62, the fused portion 40a is guided to the gap between the shaft center 62 and the inner surface 64a of the roll portion forming member 64, the fused portion 40a is easily deformed into a roll shape. The shaft center 62 may be provided at a position where the fused portion 40a starts to deform in a roll-like shape, and in FIG. 4, the shaft center 62 is provided at an A-A position and a B—B position in a schematic top view (left side in FIG. 4) and a position shown in FIGS. A and B in a schematic cross-sectional view (right side in FIG. 4). On the other hand, the shaft center 62 is not provided in the subsequent positions, i.e., in the positions shown in C—C position, D-D position, E-E position, and F—F position in the schematic top view (left side of FIG. 4) and in the positions shown in FIGS. C, D, E, and F in the schematic cross-sectional view (right side of FIG. 4).

The fused portion 40a that has started to be deformed into a roll shape is then deformed into a shape closer to a circle along the inner surface 64a of the circular shape in the roll portion forming member 64, as shown in FIGS. C, D, E, and F of C—C position, D-D position, E-E position, and F—F position and the schematic cross-sectional view (right side of FIG. 4) of the schematic top view (left side of FIG. 4) of FIG. 4 as the laminated battery 10a moves in the direction of arrow e. Then, by moving the laminated battery 10a in the direction of arrow e, the end portion 64out on the outlet side of the roll portion forming member 64, by all of the fused portion 40a passes, as shown in FIG. 3, a laminated battery 10b having a fused portion 40cc rolled from the leading end side to the roll shape is obtained.

In FIG. 4, while moving the laminated battery 10a in the direction indicated by arrow e, the roll portion forming member 64 disposed with an inclination is pressed against the fused portion 40a, thereby forming the fused portion 40cc rounded in a roll shape. However, the roll step in the embodiment of the present disclosure is not particularly limited as long as it is a step in which the fused portion can be rolled from the front end side into a roll shape. For example, by winding the shaft center at the tip of the fused portion, by winding the fused portion around the axis toward the root side of the fused portion (that is, the end of the side where the electrode in the fused portion is disposed), it is also possible to roll the fused portion from the tip side to the roll-like.

### Press Process

Next, the laminated battery 10 shown in FIG. 1 is manufactured by performing a pressing step on the laminated battery 10b having the fused portion 40cc rolled from the front end side into a roll shape by the roll step.

FIG. 5 is a schematic cross-sectional view illustrating a pressing step in a method of manufacturing a laminated battery according to an embodiment of the present disclosure.

In the pressing step shown in FIG. 5, the pressing member 82, 84, 86 is pressed against the fused portion 40cc rolled from the leading end side from three directions, press (preferably hot press). Specifically, the pressing member 82 from the lower side in FIG. 5, the pressing member 84 from the right side direction, by pressing the pressing member 86 from the further upper (preferably hot press), the angle of 90° or less by pressing (preferably), bent portion 40A, 40B at two positions bent in an angular or arcuate shape is formed. Incidentally, the surface to be pressed against the fused portion 40cc of the pressing member 84 to be pressed from the right side in FIG. 5, the angle of the bent portion 40A is less than 90° (more preferably 80° or less) angle, has an inclination. Further, the surface pressed against the fused portion 40cc of the pressing member 86 pressed from above in FIG. 5, the angle of the bent portion 40B is less than 90° (more preferably 80° or less) angle, has an inclination.

In FIG. 5, a press process of pressing the pressing member from three directions against the rounded fused portion to form two bent portions has been described. However, the pressing step in the embodiment of the present disclosure is not particularly limited as long as it is a step of forming two bent portions bent in an angular shape or an arcuate shape so as to have an angle of 90° or less. For example, two bent portions can be formed by pressing the pressing member from two directions and pressing the pressing member. Specifically, the pressing member 84 pressed from the right side direction in FIG. 5 and the pressing member 86 pressed from above may be used, and the pressing member 82 pressed from below may be pressed without using to form two bent portions.

According to the laminated battery manufacturing method according to the embodiment of the present disclosure including the roll step and the press step, it is possible to increase the structural efficiency in the fused portion and suppress the occurrence of tearing in the laminate film.

Conventionally, when two bent portions are formed in the fused portion of the laminate film, the bent members (for example, roll members) are pressed against both sides of the laminate film, and the bent portions are formed using the bent members pressed inward as fulcrums. However, stress is concentrated at the fulcrum, and thus the laminate film may be torn.

On the other hand, in the manufacturing method of the laminated battery according to the embodiment of the present disclosure, after the fused portion is rolled from the front end side to a roll shape by a roll process, by pressing the pressing member from at least two directions against the rounded fused portion, to form two bent portions bent in an angular or arcuate shape so as to have an angle of 90° or less. Therefore, as shown in FIG. 5, it is possible to form two bent portions without pressing a bending member (for example, a roll member) serving as a fulcrum on the inner side of the laminate film. Therefore, the stress concentration on the fulcrum does not occur, and the tear in the laminate film can be suppressed. In addition, since the leading end side of the fused portion is rolled, the structural efficiency of the fused portion can be increased.

Thus, according to the embodiment of the present disclosure, it is presumed that the occurrence of the tear in the laminate film can be suppressed while the structural efficiency in the fused portion is increased.

### Components of Battery

Next, an electrode body and a laminate film constituting the laminated battery according to the present embodiment will be described.

### 1. Laminate Film

The laminate film may have, for example, a structure including a metal layer and a protective resin layer on the outside of the metal layer. The laminate film may further be a three-layer film having a fusion-bonded resin layer on the inner side of the metal layer.

Examples of the adhesive resin include olefinic resins such as polypropylene (PP) and polyethylene (PE). Examples of the material of the metal layer include aluminum, aluminum alloy, and stainless steel. For example, polyethylene terephthalate (PET) or nylon may be used as the protective resin layer. The thickness of the fusion resin layer is, for example, 40 μm or more and 100 μM or less. The thickness of the metal layer is, for example, 30 μm or more and 60 μm or less. The thickness of the protective resin layer is, for example, 20 μm or more and 60 μm or less. The thickness of the entire laminate film is, for example, 70 μm or more and 220 μm or less.

### 2. Electrode Body

The electrode body functions as a power generation element of the battery. The electrode body generally includes a positive electrode current collector, a positive electrode active material layer, an electrolyte layer, a negative electrode active material layer, and a negative electrode current collector in this order in the thickness direction.

The positive electrode active material layer contains at least a positive electrode active material. The positive electrode active material layer may further contain at least one of a conductive material, an electrolyte, and a binder. The shape of the positive electrode active material is, for example, particulate. Examples of the positive electrode active material include an oxide active material. Further, sulfur (S) may be used as the positive electrode active material.

The positive electrode active material preferably contains a lithium composite oxide. The lithium composite oxide may contain at least one selected from the group consisting of F, Cl, N, S, Br, and I. The lithium composite oxide may have a crystalline structure belonging to at least one space group selected from R-3m, Immm and P63-mmc (also referred to as P63mc, P6/mmc). In addition, the in the lithium composite oxide, the main arrangement of the transition-metal, the oxygen, and the lithium may be an O2 structure. lithium composite oxide may have a structure in which the main arrangement of the transition-metal, the oxygen, and the lithium is an O2 structure.

Examples of the lithium composite oxide having a crystalline structure belonging to R-3m include compounds represented by LiₓMe_{y}O_{α}Xβ (Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X represents at least one selected from the group consisting of F, Cl, N, S, Br, and I, and 0.5≤x≤1.5, 0.5≤y≤1.0, 1≤α≤2, 0≤β≤1 are satisfied).

Examples of the lithium composite oxide having a crystalline structure belonging to Immm include: composite oxides represented by Liₓ₁M¹A¹₂ (1.5≤x1≤2.3 is satisfied, M¹ includes at least one selected from the group consisting of Ni, Co, Mn, Cu, and Fe, A¹ includes at least oxygen, and the ratio of oxygen in A¹ is 85 atomic % or more) (a specific example is Li₂NiO₂); and composite oxides represented by Liₓ₁M^{1A}₁₋ₓ₂M^{1B}ₓ₂O_{2-y}A²_{y} (0≤x2≤0.5, 0≤y≤0.3, at least one of x2 and y is not 0, M^{1A} represents at least one selected from the group consisting of Ni, Co, Mn, Cu, and Fe, M^{1B} represents at least one selected from the group consisting of Al, Mg, Sc, Ti, Cr, V, Zn, Ga, Zr, Mo, Nb, Ta, and W, and A² represents at least one selected from the group consisting of F, Cl, Br, S, and P).

Examples of the lithium composite oxide having a crystalline structure belonging to P63-mmc include composite oxides represented by M1ₓM2_{y}O₂ (M1 represents an alkali metal (at least one of Na and K is preferred), M2 represents a transition metal (at least one selected from the group consisting of Mn, Ni, Co, and Fe is preferred), and x+y satisfies 0<x+y≤2).

Examples of the lithium composite oxide having an O2 structure include composite oxides represented by Liₓ[Li_{α}(MnₐCo_{b}M_{c})_{1-α}]O₂ (0.5<x<1.1, 0.1<α<0.33, 0.17<a<0.93, 0.03<b<0.50, 0.04<c<0.33, M represents at least one selected from the group consisting of Ni, Mg, Ti, Fe, Sn, Zr, Nb, Mo, W, and Bi). Specific examples include Li_{0.744}[Li_{0.145}Mn_{0.625}Co_{0.115}Ni_{1.115}]O₂, and the like.

The positive electrode preferably includes, in addition to the positive electrode active material, a solid electrolyte selected from the group consisting of a sulfide solid electrolyte, an oxide solid electrolyte, and a halide solid electrolyte, and more preferably, at least a part of the surface of the positive electrode active material is coated with a sulfide solid electrolyte, an oxide solid electrolyte, or a halide solid electrolyte. As the halide solid electrolyte covering at least a part of the surface of the positive electrode active material, Li_{6-(4-x)b}(Ti₁₋ₓAlₓ)_{b}F₆ (0<x<1, 0<b≤1.5) [LTAF electrolyte] is preferred.

Examples of the conductive material include carbon material. The electrolyte may be a solid electrolyte or a liquid electrolyte. The solid electrolyte may be an organic solid electrolyte such as a gel electrolyte, or an inorganic solid electrolyte such as an oxide solid electrolyte or a sulfide solid electrolyte. In addition, the liquid electrolyte contains, for example, a support salt such as LiPF₆ and a solvent such as a carbonate-based solvent. Examples of the binder include a rubber-based binder and a fluoride-based binder.

The negative electrode active material layer contains at least a negative electrode active material. The negative electrode active material layer may further contain at least one of a conductive material, an electrolyte, and a binder. Examples of the negative electrode active material include metal active material such as Li and Si, carbon active material such as graphite, and oxide active material such as Li₄Ti₅O₁₂. The shape of the negative electrode current collector is, for example, a foil shape or a mesh shape. The conductive material, the electrolyte and the binder are similar to those described above.

The electrolyte layer is disposed between the positive electrode active material layer and the negative electrode active material layer, and contains at least an electrolyte. The electrolyte may be a solid electrolyte or a liquid electrolyte. The electrolyte layer is preferably a solid electrolyte layer. The electrolyte layer may have a separator.

The solid electrolyte preferably includes at least one solid electrolyte species selected from the group consisting of a sulfide solid electrolyte, an oxide solid electrolyte, and a halide solid electrolyte.

The sulfide solid electrolyte preferably contains sulfur (S) as a main component of the anionic element, and further preferably contains, for example, an Li element, an element A, and an element S. Element A is at least one selected from the group consisting of P, As, Sb, Si, Ge, Sn, B, Al, Ga, and In. The sulfide solid electrolyte may further contain at least one of O and a halogen element. Examples of the halogen element (X) include F, Cl, Br, and I. The composition of the sulfide solid electrolyte is not particularly limited, and examples thereof include xLi₂S·(100-x)P₂S₅ (70≤x≤80), yLiI·zLiBr·(100-y-z)(xLi₂S·(1-x)P₂S₅) (0.7≤x≤0.8, 0≤y≤30, 0≤z≤30). The sulfide solid electrolyte may have a composition represented by the following formula (1).

$${Li}_{4 - x} {Ge}_{1 - x} {P}_{x} {S}_{4} ( 0 < x < 1 ) \qquad ( 1 )$$

In the formula (1), at least a part of Ge may be substituted with at least one selected from the group consisting of Sb, Si, Sn, B, Al, Ga, In, Ti, Zr, V, and Nb. At least a part of P may be substituted with at least one selected from the group consisting of Sb, Si, Sn, B, Al, Ga, In, Ti, Zr, V, and Nb. A part of Li may be substituted with at least one selected from the group consisting of Na, K, Mg, Ca, and Zn. A part of S may be substituted with halogen. Halogen is at least one of F, Cl, Br, and I.

The oxide solid electrolyte preferably contains oxygen (O) as a main component of the anionic element, and may contain, for example, Li, Q element (Q represents at least one of Nb, B, Al, Si, P, Ti, Zr, Mo, W, and S), and O. Examples of the oxide solid electrolyte include a garnet-type solid electrolyte, a perovskite-type solid electrolyte, a NASICON-type solid electrolyte, a Li—P—O type solid electrolyte, and a Li—B—O type solid electrolyte. Examples of the garnet-type solid state electrolyte include Li₇La₃Zr₂O₁₂, Li₇₋ₓLa₃(Zr₂₋ₓNbₓ)O₁₂ (0≤x≤2), and Li₅La₃Nb₂O₁₂. Examples of the perovskite-type solid electrolyte include (Li, La)TiO₃, (Li, La)NbO₃, and (Li, Sr)(Ta, Zr)O₃. Examples of the NASICON-type solid electrolyte include Li(Al, Ti)(PO₄)₃, and Li(Al, Ga)(PO₄)₃. Examples of Li—P—O type solid electrolyte include Li₃PO₄, and UPON (compound in which a part of O of Li₃PO₄ is substituted with N), and examples of Li—B—O type solid electrolyte include Li₃BO₃, and a compound in which a part of O of Li₃BO₃ is substituted with C.

As the halide solid electrolyte, a solid electrolyte containing Li, M, and X (M represents at least one of Ti, Al, and Y, and X represents F, Cl or Br) is preferable. Specifically, Li₆₋₃Y_{z}X₆ (X represents Cl or Br, z satisfies 0<z<2), and Li_{6-(4-x)b}(Ti₁₋ₓAlₓ)_{b}F₆ (0<x<1, 0<b≤1.5) are preferred. Among Li_{6-3z}Y_{z}X₆, Li₃YX₆ (X represents Cl or Br) is more preferred in terms of excellent lithium ion conductivity, and Li₃YCl₆ is more preferred. Also, Li_{6-(4-x)b}(Ti₁₋ₓAlₓ)_{b}F₆ (0<x<1, 0≤b≤1.5) is preferably included together with a solid electrolyte such as a sulfide solid electrolyte, for example, from the viewpoint of suppressing oxidative decomposition of the sulfide solid electrolyte.

The positive electrode current collector collects current from the positive electrode active material layer. Examples of the positive electrode current collector include stainless steel, aluminum, nickel, iron, titanium, and carbon, and an aluminum alloy foil or an aluminum foil is preferable. The aluminum alloy foil and the aluminum foil may be manufactured using powder. The shape of the positive electrode current collector is, for example, a foil shape or a mesh shape.

The negative electrode current collector collects current from the negative electrode active material layer. Examples of the material of the negative electrode current collector include metals such as copper, SUS, and nickel. Examples of the shape of the negative electrode current collector include a foil shape and a mesh shape.

### Battery Structure

The structure of the solid battery has a laminated structure of a positive electrode, a solid electrolyte layer, and a negative electrode. The solid-state battery includes a so-called all-solid-state battery using a solid electrolyte as an electrolyte, and the solid electrolyte may include an electrolyte of less than 10 mass % based on the total amount of the electrolyte. The solid electrolyte may be a composite solid electrolyte including an inorganic solid electrolyte and a polymer electrolyte.

The positive electrode includes a positive electrode active material layer and a current collector, and the negative electrode includes a negative electrode active material layer and a current collector.

The solid electrolyte layer may have a single-layer structure or a multilayer structure of two or more layers.

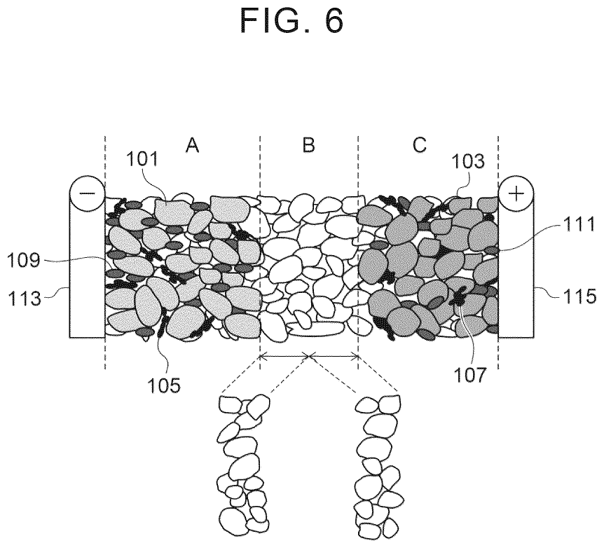

The solid battery may have, for example, a cross-sectional structure shown in FIG. 6, and the solid electrolyte layer B may have a two-layer structure as shown in FIG. 6. FIG. 6 is a schematic cross-sectional view illustrating an example of a solid-state battery. The solid-state battery illustrated in FIG. 6 includes a negative electrode including a negative electrode current collector 113 and a negative electrode active material layer A, a solid electrolyte layer B, and a positive electrode including a positive electrode current collector 115 and a positive electrode active material layer C. The negative electrode active material layer A includes a negative electrode active material 101, a conductive auxiliary agent 105, and a binder 109. The positive electrode active material layer C includes a coated positive electrode active material 103, a conductive auxiliary agent 107, and a binder 111, and the coated positive electrode active material 103 is coated with a LTAF electrolyte or a LiNbO₃ electrolyte.

Further, the solid battery may be configured by sealing the laminated end face (side face) of the laminated structure of the positive electrode/solid electrolyte layer/negative electrode with resin. The current collector may have a structure in which a buffer layer, an elastic layer, or a Positive Temperature Coefficient (PTC) thermistor layer is disposed on the surface.

### Battery

The laminated battery in the present disclosure is typically a lithium ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving hybrid electric vehicle (HEV), plug-in hybrid electric vehicle (PHEV) or battery electric vehicle (BEV). Also, the battery in the present disclosure may be used as a power source for mobile bodies other than vehicles (for example, railroads, ships, and aircraft), and may be used as a power source for electric products such as an information processing device.

The present disclosure is not limited to the above embodiments. The above embodiments are illustrative, and anything having substantially the same configuration as, and having similar functions and effects to, the technical idea described in the claims of the present disclosure is included in the technical scope of the present disclosure.

What is claimed is:

1. A laminated battery comprising:
an electrode body; and
laminate films that cover and seal the electrode body, wherein:
the laminate films include a fused portion at which end portions overlap each other and inner surfaces are fused; and
the fused portion includes two bent portions bent in an angular or arcuate shape so as to have an angle of 90° or less, and a rolled portion disposed on a distal end side of the fused portion with respect to the two bent portions and rolled in a rolled shape.

2. The laminated battery according to claim 1, wherein the bent portions have an angle of 60° or more.

3. The laminated battery according to claim 1, wherein a height of the fused portion in a thickness direction of the electrode body is equal to or less than a thickness of a portion of the laminated battery including the electrode body.

4. A method of manufacturing a laminated battery including
an electrode body, and
laminate films that cover and seal the electrode body,
the laminate films including a fused portion at which end portions of the laminate films overlap each other and inner surfaces are fused, the method comprising:
rolling the fused portion into a rolled shape from a distal end side; and
forming two bent portions by pressing the rolled fused portion from at least two directions using a pressing member and bending the fused portion into an angular or arcuate shape so as to have an angle of 90° or less.

5. The method of manufacturing a laminated battery according to claim 4, wherein the pressing includes pressing the fused portion from three directions using the pressing member.
